(19) United States
(12) Patent Application Publication
(10) Pub. No.: US 2009/0065141 A1
(43) Pub. Date: Mar. 12, 2009

(54) Method for producing a non-slip coating

(76) Inventor: Friedrich Kerber, Eichgraben (AT)

Correspondence Address: COLLARD & ROE, P.C., 1077 NORTHERN BOULEVARD, ROSLYN, NY, 11576, US

(21) Appl. No.: 12/283,678

(22) Filed: Sep. 15, 2008

Related U.S. Application Data
(63) Continuation of application No. PCT/AT2007/000131, filed on Mar. 16, 2007.

(30) Foreign Application Priority Data
Mar. 16, 2006 (AT) A 440/2006

(51) Int. Cl. B32B 38/14

(52) U.S. Cl. 156/277

(57) ABSTRACT

Method for producing a non-slip coating on a carrier (1) which is in the form of a sheet or can be unwound off a roll, for improving the friction-related treatment characteristics of the carrier (1) for subsequent treatment steps, such as for example cutting, stamping or folding processes, subsequent transport processes, or subsequent storing, a covering layer (3) consisting of non-slip material being applied to at least one of the two surfaces (5) of the carrier (1). According to the invention, provision is made for the covering layer (3) used to be lacquer which is applied only over partial areas of the surface (5) of the carrier (1). Furthermore, strip-type or sheet-type material consisting of a carrier (1), and a covering layer (3) consisting of non-slip material applied to at least one of the two surfaces (5) of the carrier (1), the covering layer (3) being a lacquer layer which is applied only over partial areas of the surface (5) of the carrier (1).

The invention relates to a method for producing a non-slip coating on a carrier which is in the form of a sheet or can be unwound off a roll, in particular for improving the treatment characteristics of the carrier for subsequent treatment steps, a covering layer consisting of non-slip material being applied to at least one of the two surfaces of the carrier, according to the preamble of claim 1.

Methods of this type are commonly used especially when strip-type or sheet-type materials are supplied to subsequent, automated sections of a plant in which further treatment takes place. This may in particular also involve a printing process in which the carrier is provided with a single-coloured or multicoloured printed layer. An example of application would for instance be the production of a packaging material, for which purpose a carrier, for example a paper web, is first unwound off a supply roll and imprinted in one or more colours, before it is finally supplied to further treatment steps such as cutting or bonding processes, or else merely storing. For trouble-free treatment of the paper web, it is accordingly necessary for the paper web to have specific treatment characteristics, for example a surface composition which ensures easy handling in usually automated transportation and treatment processes. Therefore, the paper web is for example provided with a covering layer consisting of non-slip material in order to increase the friction value, which will be referred to hereinafter also as the coefficient of friction or as the slip angle, of the carrier. Various non-slip materials are known, for example lacquers which are applied in liquid or paste-like form to one surface or both surfaces of the carrier and must subsequently harden or dry before further treatment of the carrier can take place. In order to achieve optimum friction characteristics, the entire surface to be coated of the carrier is in this case provided according to the prior art with a covering layer. This would appear to be advantageous also because this covering layer protects printed layers lying therebelow from colour abrasion and also imparts to the material a gloss which is in some cases visually attractive.

Nevertheless, the non-slip materials used for the coating are expensive, so that the advantage of improved treatment characteristics is associated with higher costs. Also, lacquers which are applied over the entire area can often be bonded very poorly to planned bonding points, as it is difficult to join the adhesive to the covering layer. Attempts are therefore often made not to provide the carrier at the planned bonding points with a covering layer. However, it must be ensured in this case that the bonding, which is usually carried out in an automated manner, takes place precisely at these recessed surface regions of the carrier; this sometimes causes difficulties. That leads in turn to higher costs, a greater risk of complaints and a greater risk of spoilage. Finally, the drying time required after the application of the covering layer reduces the overall treatment speed. Measures for more rapid drying, such as for example an increase in drying temperature, again entail higher energy costs.

DE 203 02 310 U1 proposes facilitating the use of everyday items, such as for example writing or other underlays, placemats as underlays for covers on dining tables and the like, by preventing slipping of these articles on a substrate. That is achieved using a polypropylene adhesive material as a non-slip material which has a residual tack after hardening. The adhesive material is in this case applied as a surface pattern.

DE 202 06 101 U1 proposes an anti-slip means for applying or fastening to a fixed substrate, in which an anti-slip lining is laminated in transparent form onto a signal strip.

DE 202004017840 U1 describes a plastics material planar structure comprising a planar, flexible plastics material carrier and a plastics material coating applied to the plastics material carrier, the coating forming a structured surface.

DE 199 38 828 A1 describes a paper or plastic material bag with a non-slip coating consisting of a grid-type or planar coating comprising a plastics material having a comparatively high coefficient of friction. The coating can be applied to individual points or else in the form of a grid. The aim of the non-slip coating is to avoid the slippage of palletised stacks.

JP 03241092 describes a method for producing a non-slip coating on corrugated board with the aid of a lacquer layer. The aim of such a coating is again improved storability of the material.

U.S. Pat. No. 4,421,805 also relates primarily to improving the stackability of shipping sacks by preventing mutual slippage thereof with the aid of a layer based on a polyamide resin. This layer can be applied over the entire area or else in the form of a grid.

DE 203 11 507 U1 relates to planar, non-slip material in the form of mats or rolls, which material is used as an underlay for securing heavy goods to be transported. The coating is intended in this case not to be tacky; this is achieved in that an organic monomer or polymer forming slightly tacky films, in the form of a suspension or paste consisting of “expandable microcapsules” in a solution, suspension or emulsion of the monomer or polymer, is applied to the mats. The mats are first available in the form of endless rolls which, after the coating, are cut to size accordingly. The coating takes place preferably over part of the area, for example in the form of strips.

EP 1 407 831 A2 is concerned with the production of sealing lacquer layers on sheets or sheet composites, for example with the aid of gravure printing methods. The sheets can also be made of paper and serve for example to produce a flexible packaging material. Also described are plants for a packaging material of this type using an unwinding device, a laminating station, a printing station, a print overlay coating station, a sealing coating station and a winding station following said sealing coating station. EP 1 407 831 A2 proposes in this case, with regard to the sealing coating station, a method for producing a sealing layer covering part of the area with the aid of electrostatic coating methods.

It is therefore the aim of the invention to provide methods which avoid these drawbacks. Furthermore, it would be desirable if the friction value of the strip-type or sheet-type material could be optimised for the respective subsequent treatment process; at present, this would be conceivable only by using different non-slip materials, or by using a non-slip material having for example varying viscosity. These aims are achieved by the features of claim 1.

Claim 1 relates to a method for producing a non-slip coating on a carrier which is in the form of a sheet or can be unwound off a roll, for improving the friction-related treatment characteristics of the carrier for subsequent treatment steps, such as for example cutting, stamping or folding processes, a covering layer consisting of lacquer being applied to at least one of the two surfaces of the carrier, the lacquer being printed on only over partial areas of the surface of the carrier, and prior to the application of the covering layer, a single-coloured or multicoloured printing process takes place on the surface of the carrier. According to the invention, provision is in this case made for the covering layer is applied in the form of a grid. The reason for this is that it has surprisingly been found that the slip angle of a material is significantly higher, compared to coating with the covering layer over the entire area, if the surface is not coated all over. Thus, not only can the slip angle be increased, as is often broadly desirable, for example in the packaging industry, but rather expensive material for producing the covering layer can at the same time be saved.

Specifically, observations made by the Applicant reveal that the slip angle first increases, starting from coating of the carrier over the entire area, if the coverage ratio, i.e. the ratio between the partial areas covered by the covering layer and the total area of the respective surface of the carrier, is reduced, starting from a value of 100%, to lower percentages. Further reduction of the coverage ratio ultimately leads to passing-through of a maximum value of the slip angle which is greater than the slip angle in the case of coating over the entire area. After passing through this maximum value, the anticipated behaviour is finally established in that the slip angle decreases, the smaller the partial areas of the surface of the carrier which are provided with the covering layer are selected to be. At a specific coverage ratio, ultimately the same slip angle is established as when the surface is completely covered. However, this situation itself leads to a considerable saving in non-slip material for the covering layer. If the coverage ratio is further reduced, the slip angle eventually drops below this value and subsequently decreases more and more until it assumes that value which corresponds to the slip angle of the uncoated carrier.

The subsequent treatment steps mentioned in claim 1 can in this case be steps for machining the coated carrier, such as for example cutting, stamping or folding processes.

For the covering layer to be applied in the form of a grid, a person skilled in the art has at his disposal a plurality of printing methods with which he is very familiar and which allow the non-slip material to be applied to the surface of the carrier in the form of a grid. Varying the grid allows the above-mentioned coverage ratios to be ensured, as will be described in greater detail below. The coverage ratio will also be referred to hereinafter in conjunction with a grid as the “percentage of the grid”.

Claim 2 utilises the observation that varying the coverage ratio allows the slip angle of the material to be purposefully altered. That is to say, according to claim 2, the ratio between the partial areas covered by the covering layer and the total area of the respective surface of the carrier is selected as a function of the desired friction value (slip angle) of the surface. This allows the friction value of the strip-type or sheet-type material to be adapted to the respective subsequent treatment process.

Claim 3 provides for the layer thickness of the covering layer to be selected as a function of the desired friction value of the surface. Should, for example, the impression of a closed covering layer be necessary for the purposes of gloss, the coverage ratio can be selected so as to be higher while at the same time reducing the layer thickness. It is thus possible to obtain the visual impression of a closed covering layer, but nevertheless achieve a considerable saving owing to the reduced layer thickness.

Claim 4 proposes that the carrier used be paper, cardboard, textiles, aluminium foils, plastics material films or composite sheets made of at least two of the aforementioned materials.

The invention will be described hereinafter in greater detail with reference to the appended drawings, in which:

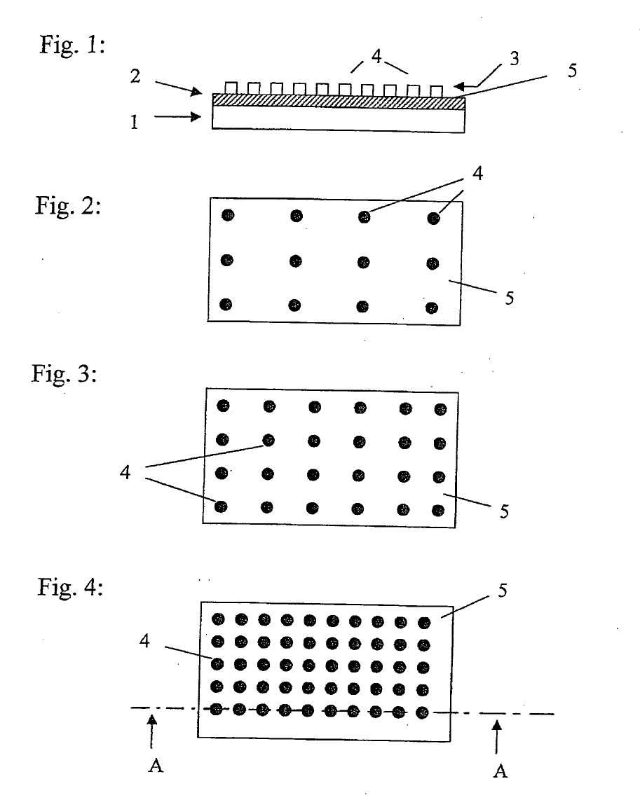

FIG. 1 is a schematic cross section along the line A-A from FIG. 4 of a portion of a material according to the invention consisting of a carrier, a printed layer and a covering layer;

FIG. 2 is a schematic view of the material from FIG. 1, viewed from above, for a first coverage ratio;

FIG. 3 is a schematic view of the material from FIG. 1, viewed from above, for a second coverage ratio; and

FIG. 4 is a schematic view of the material from FIG. 1, viewed from above, for a third coverage ratio.

FIG. 1 is a schematic view of a material according to the invention consisting of a carrier 1, optionally a printed layer 2, and a covering layer 3. The carrier 1 can for example be a paper web, a sheet of paper, a cardboard, a textile, an aluminium foil, a plastics material film, a composite sheet made of at least two of the aforementioned materials or the like. In any case, the carrier 1 can be unwound off a roll or in the form of a sheet, and is not suitable to be supplied to subsequent treatment steps during the course of automated treatment processes.

The printed layer 2 can also consist of a plurality of coloured layers, for example if a plurality of coloured planes are applied during the course of the imprinting of the carrier 1.

As mentioned hereinbefore, it is necessary for trouble-free treatment of the carrier 1 in subsequent treatment steps for the carrier 1 to have specific treatment characteristics, for example a surface composition which ensures easy handling in usually automated transportation and treatment processes. Therefore, the carrier 1 is provided with a covering layer 3 consisting of non-slip material in order to increase the friction value of the carrier 1. FIG. 1 shows for example that only the upwardly oriented surface of the carrier 1 or the printed layer 2 is provided with a covering layer 3, but not the downwardly oriented surface of the carrier 1. However, it is also possible for both surfaces of the carrier 1 to be provided with a printed layer 2 and/or a covering layer 3.

Various non-slip materials are known, for example lacquers which are applied in liquid or paste-like form to one or both surfaces of the carrier 1 and subsequently must harden or dry before further treatment of the carrier 1 can take place. These lacquers are colourless, gloss or matt drying materials which are applied to the carrier 1 or the printed layer 2 either as a printing lacquer by the printing machine or as a water-based dispersion lacquer by an independent printing lacquering unit. Within the printing process, the lacquering is usually the last printing phase and not only improves the appearance of a printed product, but rather also increases, especially in the case of matt paper, the abrasion resistance of the printed colours of the printed layer 2. However, last but not least, these lacquers also have a non-slip effect which is utilised in the case of a subsequent treatment of the printed product. In the conventional manner, the entire surface to be coated of the carrier 1 is in this case provided with a covering layer 3 in order to achieve optimum friction characteristics. The covering layer 3 also has the purpose of protecting the printed layer 2 lying therebelow from colour abrasion.

However, according to the invention, provision is made for the covering layer 3 to be applied only over partial areas of the surface of the carrier 1. As mentioned hereinbefore, the slip angle of a material is significantly higher, compared to coating with the covering layer 3 over the entire area, if the surface is not coated all over. In a preferred manner, the covering layer 3 is applied for example in the form of a grid, the shape of the grid being in principle immaterial. Depending on the case of application, different grid shapes can prove to be suitable, the selection of the optimum grid shape being a conventional task for a person skilled in the art. Different coverage ratios can be ensured by varying the grid. FIG. 2 to 4 show for instance a simple example of a grid consisting of individual grid points 4 arranged in a uniform arrangement over the surface 5 of the carrier 1 or the printed layer 2. A grid point 4 is in this case a printable image element which can be applied at various distances from one another or in various sizes. The grid shown by way of example in FIG. 2 to 4 would correspond for instance to a frequency-modulated grid, i.e. a grid in which the surface 5 is divided into grid points 4 of the same size, the percentage of the grid, i.e. of the coverage ratio, being varied over the number of points in the area (the frequency). The grid points 4 could in this case also be arranged stochastically. In contrast thereto, the surface 5 could however also be divided into a fixed number of grid points 4 (for example a “24 grid”: 24×24 points per cm²), and the percentage of the grid could be varied over the size of the points (the amplitude), this case also being known as an amplitude-modulated grid. These two types of grid can however also be combined. FIG. 2 to 4 illustrate schematically a grid shape having in each case differing percentages. FIG. 2 shows for example a grid having a comparatively low coverage ratio. If, for example, 30% of the total area of the surface 5 is covered with grid points 4, the grid is also said to be a “30% grid”. In FIG. 3, the number of grid points 4 has been increased and represents for example a “50% grid”. Finally, FIG. 4 illustrates schematically a “70% grid”. All other types of grid shapes and coverage ratios are however also conceivable.

For applying the grid point 4, a person skilled in the art has at his disposal a plurality of well-known printing methods with which the non-slip material can be applied to the surface 5 of the carrier 1 in the form of a grid. The selection of the optimum printing method will depend on the characteristics of the carrier 1 or the printed layer 2, on the requirements owing to the subsequent treatment steps, on the nature of the non-slip material, or else simply on the question of cost. Depending on the case of application, a person skilled in the art will thus opt for different relief, planographic, gravure or through-printing methods, such as for example flexographic printing, offset printing, screen printing, or else thermal printing methods. The substantive invention can in any case be carried out using all these printing methods.

If the starting point taken is a carrier 1 made of a specific material, for example a sheet of paper, then this carrier 1 has, after imprinting with the printed layer 2, a specific friction value (slip angle). This slip angle is smaller than that slip angle which is obtained in the event of lacquering with the covering layer 3 over the entire surface. Lacquering with the covering layer 3 over the entire surface in the form of a grid is what is known as a “100% grid”. As mentioned hereinbefore, the slip angle first increases, starting from such coating of the carrier 1 or the printed layer 2 over the entire surface, when the percentage of the grid is reduced, for example to a 70% grid (FIG. 4). In the event of further reduction of the coverage ratio, there is finally passed through, for example in the case of a 50% grid (FIG. 3), a maximum value of the slip angle which is greater than the slip angle in the event of coating over the entire area. Once this maximum value has been passed through, the anticipated behaviour is finally established in that the slip angle decreases, the smaller the partial areas of the surface 5 of the carrier 1 which are provided with the covering layer 3 are selected to be. At a specific coverage ratio, the same slip angle is ultimately established as when the surface is completely covered. In a 24 grid, that would for example be the case in a 30% grid (illustrated in FIG. 2). However, this situation already leads to a considerable saving in non-slip material for the covering layer 3 of approximately 70%. In the event of further reduction of the coverage ratio, the slip angle finally falls below this value and subsequently decreases more and more until it assumes that value corresponding to the slip angle of the uncoated carrier 1 or the printed layer 2.

Varying the coverage ratio therefore allows the slip angle of the lacquered printing unit to be purposefully altered. The ratio between the partial areas covered by the covering layer 3 and the total area of the respective surface 5 of the carrier 1 must merely be selected as a function of the desired friction value (slip angle) of the surface 5. This allows the friction value of the strip-type or sheet-type material according to the invention to be adapted to the respective subsequent treatment process.

With the method according to the invention or the material according to the invention, it is thus possible to reduce the amount of non-slip material used for the coating; this is associated with a significant reduction in cost. Furthermore, bonding processes can be carried out more easily as, owing to the grid, the adhesive, for example glue, can establish a connection to the carrier 1, for example paper, and thus obtain the necessary bonding characteristics. That leads in turn to lower costs, and also to a lesser risk of complaints and spoilage. Finally, owing to the smaller amounts of the material necessary for the covering layer 3, the required drying time can be reduced, and this increases the overall treatment speed. Measures for more rapid drying, such as for example an increase in the drying temperature or the like, are no longer necessary or are necessary to a reduced extent.

1. Method for producing a non-slip coating on a carrier (1) which is in the form of a sheet or can be unwound off a roll, for improving the friction-related treatment characteristics of the carrier (1) for subsequent treatment steps, such as for example cutting, stamping or folding processes, a covering layer (3) consisting of lacquer being applied to at least one of the two surfaces (5) of the carrier (1), the lacquer being printed on only over partial areas of the surface (5) of the carrier (1), and prior to the application of the covering layer (3), a single-colored or multi-colored printing process takes place on the surface (5) of the carrier (1), wherein the covering layer (3) is applied in the form of a grid.

2. Method according to claim 1, wherein the ratio between the partial areas covered by the covering layer (3) and the total area of the respective surface (5) of the carrier (1) is selected as a function of the desired friction value of the surface (5).

3. Method according to claim 1, wherein the layer thickness of the covering layer (3) is selected as a function of the desired friction value of the surface (5).

4. Method according to claim 1, wherein the carrier (1) used is paper, cardboard, a textile material, an aluminum foil, a plastics material film, or a composite sheet made of at least two of the aforementioned materials.
